(19) United States
(12) Patent Application Publication
(10) Pub. No.: US 2020/0023544 A1
(43) Pub. Date: Jan. 23, 2020

(54) ADJUSTABLE FLANGE ASSEMBLY FOR A CUTTING TOOL

(71) Applicant: NAP ASSET HOLDINGS LTD., Wilmington, DE (US)

(72) Inventor: Philippe TURCOT, Marieville (CA)

(21) Appl. No.: 16/042,344

(22) Filed: Jul. 23, 2018

(51) Int. Cl. B27F 1/02; B27G 13/14

(52) U.S. Cl. CPC B27F 1/02; B27G 13/14

(57) ABSTRACT

There is disclosed an adjustable flange assembly for securing a cutting tool to a shaft rotatable about an axis. The adjustable flange assembly has a support plate defining an aperture for receiving the shaft and defining a reference surface on a first side thereof. The reference surface is in abutment with the cutting tool. A securing mechanism is operatively connected to the support plate and operable for releasably securing the support plate to the shaft. A deformable plate is secured to the support plate and is in abutment against a shoulder of the shaft. Adjustment members are mounted on one of the support plate and the deformable plate and are operable to exert a force on the deformable plate to locally deform the deformable plate.

### TECHNICAL FIELD

The application relates generally to cutting tools and, more particularly, to systems and methods used for correcting the lateral run-out of such cutting tools.

### BACKGROUND OF THE ART

Hard wood floors typically include a plurality of planks secured to one another using a tongue-and-groove arrangement. Machines are used to machine a tongue and a groove respectively on opposed sides of the planks. Such a machine includes a shaft on which a cutting tool is secured. The cutting tool includes a plurality of knife inserts secured to its circumference.

Once the tongues and grooves are machined, there is usually no more operation carried along the profiled sides of the plank (i.e. there is no sanding of the tongues and grooves). To ensure a precise machining, the knife inserts are partially abraded away using a stone model that corresponds to a shape of either one of the tongue or the groove. The stone model is made of a material harder than a material of the knife inserts. The cutting tool is rotated and the stone is slowly brought in proximity to the knife inserts. Portions of knife inserts that are outside manufacturing tolerances will be grinded away by the stone.

To increase productivity, it is desirable to feed the planks to the machine as fast as possible. Furthermore, the less frequent the knife inserts have to be sharpen the better. Therefore, it might be advantageous to use knife inserts made of diamond and/or carbide, which are very hard materials. Using such materials might allow to decrease the sharpening frequency of the knife inserts and increase productivity. However, such hard materials may not be profiled using a stone model because the stone model is not sufficiently hard to abrade away portions of the knife inserts made of carbide/diamonds.

Adjusting the knife inserts to accurately machine the tongues and the grooves is complicated because rotation of the shaft of the machine may induce a radial run-out. The radial run-out corresponds to variations of a radius of the shaft when in rotation. It is typically measurable by disposing a gauge or probe sensor in contact with a cylindrical surface of the shaft and by rotating the shaft relative to the gauge. The radial run-out corresponds to a variation between minimum and maximum values measured by the gauge. The shaft may also present a lateral, or axial, run-out. The lateral run-out appears when the radial run-out of the shaft varies along a rotation axis of the shaft. In other words, the lateral run-out will be present if the radial run-out at a first axial position on the shaft is different than that at a second axial position of the shaft relative to its rotation axis. The lateral run-out induces the knife inserts of the cutting tool to go up and down when the cutting tool and the shaft are driven in rotation. When manufacturing a groove, the radial run-out causes a depth of the groove to vary along the length of the plank whereas the lateral run-out induces up and down waves in the groove along the length of the plank.

Existing systems used for correcting the radial and lateral run-outs have drawbacks. There is therefore still a need for improvements.

### SUMMARY

In one aspect, there is provided an adjustable flange assembly for mounting a cutting tool to a shaft rotatable about an axis, the shaft having a shoulder, the adjustable flange assembly comprising: a support plate defining an aperture for slidably receiving the shaft therethrough, the support plate defining a reference surface at a periphery of a first side thereof, the reference surface being annular, extending around the aperture, and configured for being in abutment with the cutting tool; a securing mechanism operatively connected to the support plate and operable for releasably securing the support plate to the shaft; a deformable plate defining an opening for slidably receiving the shaft therethrough, the deformable plate secured to a second side of the support plate opposite the first side, the deformable plate configured for being in abutment against the shoulder of the shaft; and adjustment members mounted on one of the support plate and the deformable plate at a plurality of circumferential locations around the axis, the adjustment members being operable to exert a force on the deformable plate to locally deform the deformable plate from an undeformed stated to a deformed state, an axial distance between the support plate and the deformable plate at a corresponding one of the circumferential locations being greater in the deformed state than that in the undeformed state, an axial position of the reference surface at the corresponding one of the circumferential location varying from the undeformed state to the deformed state.

In another aspect, there is provided an assembly for rotation about a shaft, the shaft having an axis and a shoulder, the assembly comprising: a cutting tool securable to the shaft and rotatable about the axis, the cutting cool having an axial end annular wall; an adjustable flange assembly including a support plate and a deformable plate secured to the support plate, the support plate and the deformable plate having registering apertures for slidably receiving the shaft therethrough, the deformable plate abuttable against the shoulder of the shaft and located axially between the axial end annular wall of the cutting tool and the support plate relatively to the axis, a securing mechanism operatively connected to the support plate and operable for releasably securing the support plate to the shaft, adjustment members mounted on one of the support plate and the deformable plate at a plurality of circumferential locations around the axis, the adjustment members being operable to exert a force on the deformable plate to locally deform the deformable plate from an undeformed stated to a deformed state, an axial distance between the support plate and the deformable plate at a corresponding one of the circumferential locations being greater in the deformed state than that in the undeformed state, an axial position of a reference surface defined by the support plate at the corresponding one of the circumferential location varying from the undeformed state to the deformed state.

In yet another aspect, there is provided a method for securing a cutting tool to a shaft rotatable about an axis, comprising: abutting a deformable plate of an adjustable flange assembly against a shoulder of the shaft; securing a support plate of the adjustable flange assembly to the shaft; abutting the cutting tool against a reference surface defined by a side of the support plate; and deforming the deformable plate at at least one circumferential location thereby pushing the support plate at the at least one circumferential location in an axial direction relative to the axis away from the shoulder until the reference surface, at the at least one circumferential location, moves to a desired position axially offset from an initial position.

### DESCRIPTION OF THE DRAWINGS

Reference is now made to the accompanying figures in which:

FIG. 1 is a schematic partial tridimensional view of a cutting tool in accordance with one embodiment;

FIG. 2 is a schematic top perspective view of an adjustable flange assembly for the cutting tool of FIG. 1 in accordance with one embodiment;

FIG. 3 is a schematic bottom perspective view of the adjustable flange assembly of FIG. 2;

FIG. 4 is a schematic cross-sectional view of the adjustable flange assembly of FIG. 2 shown in an undeformed state; and

FIG. 5 is a schematic cross-sectional view of the adjustable flange assembly of FIG. 2 shown in a deformed state.

### DETAILED DESCRIPTION

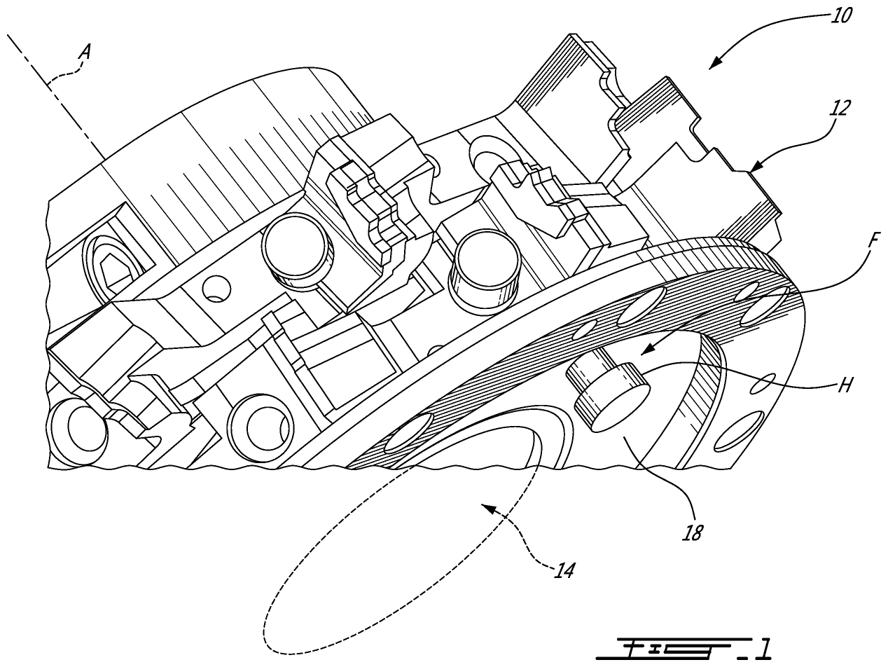

Referring to FIG. 1, a cutting tool is generally shown at 10. The cutting tool is rotatable about an axis A and has a plurality of knife holders 12 along its periphery. The knife holders 12 are configured for receiving knife inserts that are used for machining either one of tongues and grooves in hardwood planks. It is however understood that the features described herein are not limited for cutting tools used for machining tongues and grooves and may be used in any rotating tools. The knife inserts may consist of diamond and/or carbide profiled inserts or other similar wear resistant material inserts offering long working life and high quality surface finish.

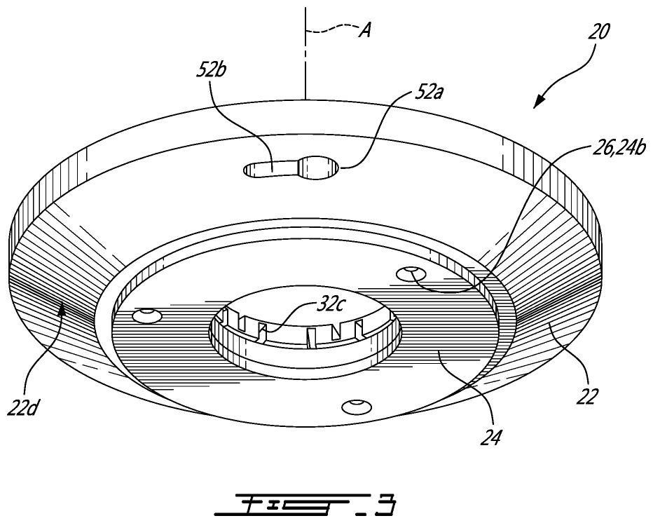

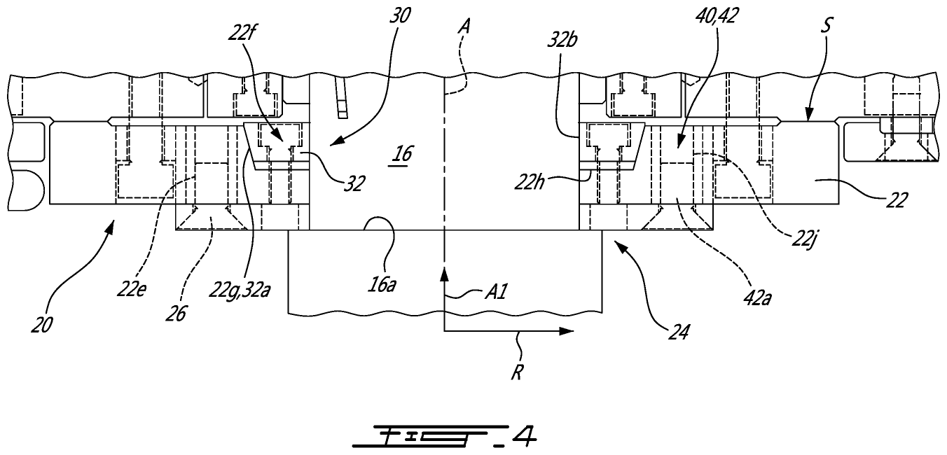

The cutting tool 10 has a central aperture 14 configured for slidably receiving a shaft 16 (FIG. 3) of a machine therein. The cutting tool 10 has an axial end annular wall 18 that surrounds the central aperture 14. The machine is configured for rotating the shaft 16 and the cutting tool 10 secured thereto. A securing mean (not shown) (e.g., hydraulic sleeves) of the cutting tool 10 is used to secure the cutting tool 10 to the shaft 16 such that the cutting tool 10 rotates integrally with the shaft 16. Typically, the shaft 16 of the machine has a shoulder 16a (FIG. 4) created by a variation in its diameter.

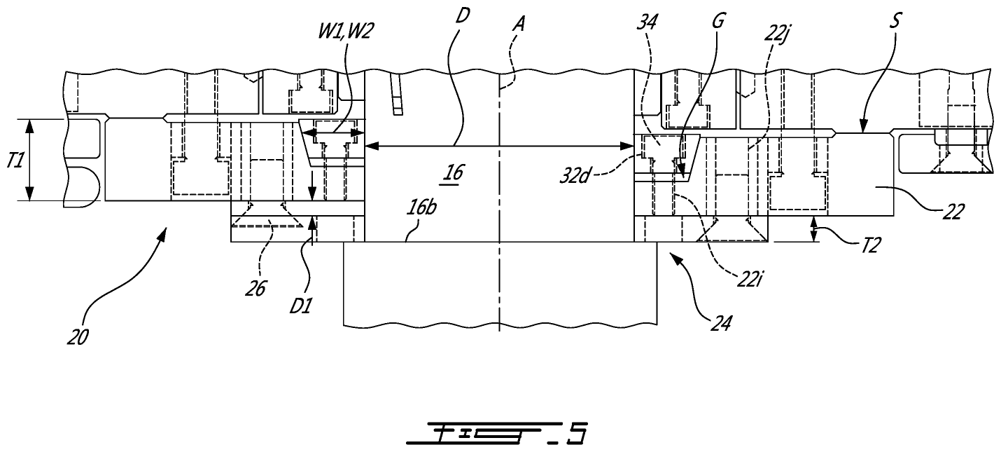

In prior art systems, the axial end annular wall 18 of the cutting tool 10 is directly in abutment with the shoulder 16a of the shaft 16 when the cutting tool 10 is secured to the shaft 16. More specifically, in prior art systems, the axial end annular wall 18 of the cutting tool 10 is in contact with an annular surface 16b (FIG. 5) defined by the shaft shoulder 16a. However, this annular surface 16b is usually too small and machined with insufficient precision for being used as a reliable reference surface for accurately positioning the cutting tool 10 on the shaft 16.

The securing mean might help in correcting at least partially the radial run-out. However, when the radial run-out varies along the length of the shaft, a lateral run-out remains. The lateral run-out causes waves in the grooves along the length of the planks.

If the knife inserts are made of steel or other similar materials, the lateral run-out is corrected by grinding the knife inserts with a stone model. The stone model is made of a material harder than a material of the knife inserts and has a shape corresponding to that of either the tongue or the groove. The cutting tool 10 is rotated and the stone is slowly brought in proximity to the knife inserts. Portions of knife inserts that are outside manufacturing tolerances will be grinded away by the stone. However, this solution prevents using harder materials for the knife inserts because such materials are too hard to be grinded by the stone. Indeed, if the knife inserts are made of carbide and/or diamond—which is desirable to decrease the sharpening frequency and hence increase productivity—it is not possible to correct the lateral run-out in this way because the stone model is not sufficiently hard relative to the knife inserts. In other words, the knife inserts, when made of carbide and/or diamonds, might be too hard to be corrected by the stone model.

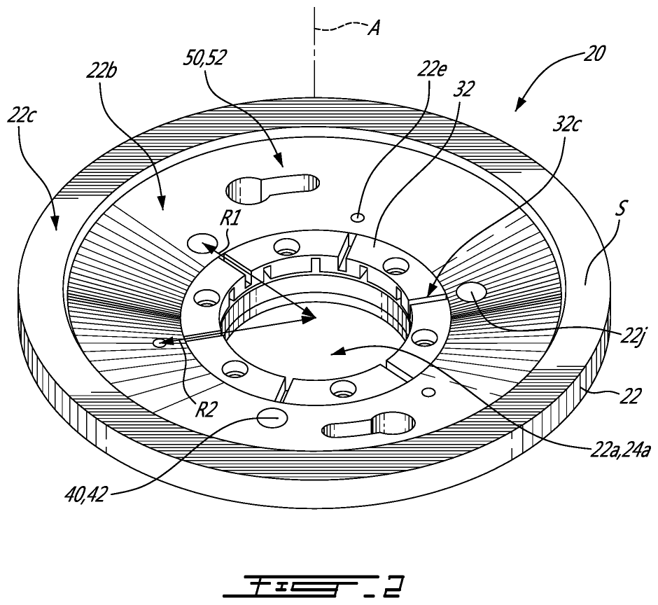

Referring now to FIGS. 2-5, an adjustable flange assembly is generally shown at 20. The adjustable flange assembly 20 is used to create a reference surface S on which the cutting tool 10 may be laid and secured. The adjustable flange assembly 20 might provide an adjustability of the reference surface S such that local adjustments of the reference surface S are allowed to compensate for the lateral run-out.

As shown, the adjustable flange assembly 20 has a support plate 22 and a deformable plate 24 both defining central hole or registered apertures 22a, 24a for slidably receiving the shaft 16. In the illustrated embodiment, the support plate 22 and the deformable plate 24 have a disc shape. The support and deformable plates 22, 24 may both be made of a metallic material such as steel.

Referring briefly to FIG. 5, the deformable plate 24 and the support plate 22 may be made of the same material. Therefore, to ensure that it is the deformable plate 24 that deforms, a thickness T1 of the support plate 22 taken in the axial direction A1 relative to the axis is greater than a thickness T2 of the deformable pate 24. It is understood that the thicknesses T1, T2 of the support plate 22 and of the deformable plate 24 may be equivalent if, for instance, the deformable plate 24 is made of a material that is less stiff than the material the support plate 22 is made of. Other configurations are contemplated without departing from the scope of the present disclosure.

Referring back to FIGS. 2-5, the reference surface S of the adjustable flange assembly 20 is located on a first side 22b of the support plate 22 and as illustrated may be embodied in the form of an annular peripheral surface at the outer diameter of the support plate 22. In the depicted embodiment, the first side 22b of the support plate 22 has an elevated section 22c located adjacent its outer periphery. The reference surface S is located at the elevated section 22c of the support plate first side 22b.

As shown more clearly on FIG. 4, the deformable plate 24 is sandwiched between the support plate 22 and the shoulder 16a of the shaft 16. In other words, the deformable plate 24 is located axially between the support plate 22 and the shoulder 16a of the shaft 16 relative to the axis A. In the depicted embodiment, the deformable plate 24 is in abutment against a second side 22d of the support plate 22 opposite the first side 22b. The deformable plate 24 is configured for abutting against the shoulder 16a of the shaft 16.

Referring more particularly to FIGS. 2-3, the deformable plate 24 is secured to the support plate 22 at the second side 22d of the support plate 22 via fasteners 26, three in the depicted embodiment, that may be circumferentially equally spaced apart from one another. Hence, in the depicted embodiment, each two adjacent one of the three fasteners 26 are spaced apart by 120 degrees relative to the axis A. Each of the fasteners 26 is slidably received within apertures 24b of the deformable plate 24 and within correspondingly threaded apertures 22e of the support plate 22. The threaded apertures 22e of the support plate 22 are aligned with the apertures 24b of the deformable plate 24.

As shown more clearly on FIGS. 4-5, the support plate 22 has a counterbore or annular groove 22f around the aperture 22a on its first side 22b. The annular groove 22f is delimited radially by a beveled wall 22g of the support plate 22 that circumferentially extends around the axis A. The annular groove 22f is delimited axially by a seat 22h (e.g. flat bottom of the counterbore) located on the first side 22b of the support plate 22. The beveled wall 22g, when seen in a cross-section on a plane containing the axis A (e.g. as shown on FIG. 4), is a line that defines a first angle with the axis A. The first angle is such that a radial width W1 (FIG. 5) of the groove 22f decreases from the first side 22b toward the second side 22d of the support plate 22 and toward the seat 22h of the groove 22f.

A securing mechanism for securing the adjustable flange assembly 20 to the shaft 16 is generally shown at 30. In the depicted embodiment, the securing mechanism 30 includes a wedge member, which can for instance take the form of a ring 32 slidably received within the support plate annular groove 22f. The ring 32 has a radially outer peripheral wall 32a and a radially inner peripheral wall 32b. The radially outer peripheral wall 32a of the ring 32 is beveled and matingly abuts against the beveled wall 22g of the support plate 22 that radially delimits the annular groove 22f. The ring radially outer peripheral wall 32a, when seen in the cross-section on the plane containing the axis A, is a line that defines a second angle. The second angle corresponds substantially to the first angle and is such that a width W2 (FIG. 5) of the ring 32 taken in a radial direction R relative to the axis A varies along an axial direction A1 relative to the axis A.

The ring 32 has a plurality of indentations 32c (FIG. 3) circumferentially interspaced along its circumference. The indentations 32c are defined by the radially outer and inner peripheral walls 32a, 32b. The indentations are used to enable a deformability of the ring 32 to thereby allow the ring 32 to vary in diameter when a force is applied to the ring 32 along the radial direction R. As shown, the indentations 32c are located on both sides of the ring 32. In the embodiment shown, the ring is made of a metallic material, preferably steel. However, it is understood that the ring may be made of other materials and that the indentations may be omitted.

Referring now more particularly to FIGS. 4-5, fasteners 34 extend through apertures 32d that extend through the ring 32 in the axial direction A1. The fasteners 34 threadingly engage correspondingly threaded apertures 22i of the support plate 22. In a first position depicted in FIG. 5, an axial gap G is present between the seat 22h of the annular groove 22f and the ring 32. Upon actuation, the fasteners 34 are operable to move the ring 32 toward the seat 22h of the annular groove 22f from the first position to an unshown second position. A size of the gap G decreases as the ring 32 moves toward the seat 22h of the annular groove 22f from the depicted first position to the second position. By moving the ring 32 toward the seat 22h of the annular groove 22f, the radially outer peripheral wall 32a of the ring 32 slides against the beveled wall 22g of the annular groove 22f. The beveled wall 22g of the annular groove 22f thereby pushes against the radially outer peripheral wall 32a of the ring 32. For the ring to continue is motion toward the seat 22h, a diameter D of the ring 32 has to decrease. This decrease in diameter is possible by a wedging action created by the abutment of the annular groove beveled wall 22g and the ring radially outer peripheral wall 32a that is correspondingly angled to follow the shape of the annular groove beveled wall 22g. Therefore, the diameter D of the ring 32 in the second position is less than that in the first position. The inner peripheral wall 32b of the ring 32 is in a tight engagement with the shaft 16 at least in the second position such that rotation of the support plate 22 relative to the shaft 16 is limited, preferably blocked. It is understood that, in the first position, the ring inner peripheral wall 32b may be in contact with the shaft 16 but may not exert any force on said shaft 16. The actuation of the fasteners 34, and movement of the ring 32 along the annular groove 22f, induces a tightening force of the ring 32 against the shaft 16. The fasteners 34 are thereby actuated until the tightening force is suitable to maintain the adjustable flange 20 in integral rotation with the shaft 16 when the shaft 16 is in rotation.

It is understood that the securing mechanism 30 may be any other mean known in the art, such as a hydraulic sleeve secured to the support plate 22. The hydraulic sleeve, upon hydraulic pressure, would deform to exert a pressure on the shaft 16 and to secure the support plate 22 to the shaft 16 via the sleeve.

Once the adjustable flange assembly 20 is secured to the shaft 16, the reference surface S may still present a lateral run-out. As will be seen hereinbelow, the adjustable flange assembly 20 allows for making small adjustments to the reference surface S to at least partially eliminate this lateral run-out. Once the reference surface S of the support plate 22 is substantially free of the lateral run-out, the cutting tool 10 may be secured thereto.

Referring to FIGS. 2-5, the adjustable flange assembly 20 further includes adjustment members 40, three in the depicted embodiment, that are used to correct the lateral run-out of the reference surface S. It is understood that more adjustment members 40 may be used. In a particular embodiment, four adjustment members are used. The adjustment members 40 are mounted on one of the support plate 22 and the deformable plate 24 at a plurality of circumferential locations around the axis A and may be circumferentially equally spaced from one another. In the depicted embodiment, the adjustment members 40 are mounted on the support plate 22. As shown, each of the adjustment members 40 is circumferentially located between two adjacent ones of the fasteners 26 that are used to secure the deformable plate 24 to the support plate 22. In the embodiment shown, a radial distance R1 between each of the adjustment members 40 and the axis A is equal to a radial distance R2 between each of the fasteners 26 securing the deformable plate 24 to the support plate 22 and the axis A.

The adjustment members 40 are operable to exert a force on the deformable plate 24 to locally deform the deformable plate 24 from an undeformed state as shown on FIG. 4 to a deformed state as shown on FIG. 5. For each of the adjustment members 40, an axial distance D1 (FIG. 5) between the support plate 22 and the deformable plate 24, at a corresponding one of the circumferential locations, is greater in the deformed state than it is in the undeformed state. Therefore, an axial position of the reference surface S at the corresponding one of the circumferential location axially varies from the undeformed state to the deformed state.

Therefore and in a particular embodiment, by locally changing the axial position of the reference surface S at the plurality of circumferential locations allows to remove at least partially the lateral run-out that remains once the support plate 22 is secured to the shaft 16. The reference surface S of the support plate 22 is now the new reference surface S on which the cutting tool 10 is laid and replaces the shoulder 16a of the shaft 16 that is no longer used as a reference surface.

In the embodiment shown, the adjustment members 40 are fasteners 42 threadingly engaged within correspondingly threaded apertures 22j extending through the support plate 22 in the axial direction A1. Tips 42a (FIG. 4) of the fasteners 42 are in abutment against the deformable plate 24. Alternatively, it is understood that the fasteners 42 may extend to threaded apertures defined in the deformable plate 24 and that the tip 42a of the fasteners 42 may be in abutment against the second side 22d of the support plate 22.

Once the lateral run-out has been at least partially corrected, the cutting tool 10 may be secured to the adjustable flange assembly 20. To do so, and as shown in FIGS. 1-3, the adjustable flange assembly 20 has a locking mechanism 50. The locking mechanism 50 is used for preventing rotation of the cutting tool 10 relative to the support plate 22. As shown, the locking mechanism 50 includes at least one slotted hole 52, two in the embodiment shown, that each defines a round section 52a and an elongated section 52b that extends circumferentially from the round section 52a relatively to the axis A. The slotted hole 52 is configured for receiving a head H of at least one fastener F that is secured to the axial end annular wall 18 of the cutting tool 10. As known in the art, rotation of the cutting tool 10 relative to the support plate 22 has for effect of sliding the fastener F along the elongated section 52b of the slotted hole 52 such that the head H of the fastener F becomes locked. It is understood that the locking mechanism 50 may alternatively include fasteners to fixedly attach the cutting tool 10 to the support plate 22. Any locking mechanism that prevents rotation of the cutting tool 10 relative to the support plate 22 may be used without departing from the scope of the present disclosure.

For securing the cutting tool 10 to the shaft 16, the deformable plate 24 is abutted against the shoulder 16a of the shaft 16. The support plate 22 is secured to the shaft 16. The cutting tool 10 is abutted against the reference surface S of the support plate 22. The deformable plate 24 is deformed at at least one circumferential location thereby pushing the support plate 24, at the at least one circumferential location, in the axial direction A1 relative to the axis A away from the shoulder 16a until the reference surface S, at the at least one circumferential location, moves to a desired position axially offset from an initial position.

In the depicted embodiment, deforming the deformable plate 24 includes rotating at least one of the fastener 42 within an associated one of the correspondingly threaded apertures 22j of the support plate 22 and pushing the deformable plate 24, at the corresponding circumferential location, away from the support plate 22 with the fastener 42 having a tip 42a in abutment against the deformable plate 24.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. An adjustable flange assembly for mounting a cutting tool to a shaft rotatable about an axis, the shaft having a shoulder, the adjustable flange assembly comprising:
a support plate defining an aperture for slidably receiving the shaft therethrough, the support plate defining a reference surface at a periphery of a first side thereof, the reference surface being annular, extending around the aperture, and configured for being in abutment with the cutting tool;
a securing mechanism operatively connected to the support plate and operable for releasably securing the support plate to the shaft;
a deformable plate defining an opening for slidably receiving the shaft therethrough, the deformable plate secured to a second side of the support plate opposite the first side, the deformable plate configured for being in abutment against the shoulder of the shaft; and
adjustment members mounted on one of the support plate and the deformable plate at a plurality of circumferential locations around the axis, the adjustment members being operable to exert a force on the deformable plate to locally deform the deformable plate from an undeformed stated to a deformed state, an axial distance between the support plate and the deformable plate at a corresponding one of the circumferential locations being greater in the deformed state than that in the undeformed state, an axial position of the reference surface at the corresponding one of the circumferential location varying from the undeformed state to the deformed state.

2. The adjustable flange assembly of claim 1, wherein the securing mechanism includes a ring slidably received within an annular groove located on the first side of the support plate, the annular groove delimited radially by a beveled wall that circumferentially extends around the axis and axially by a seat, the ring having a radially outer peripheral wall and a radially inner peripheral wall, the radially outer peripheral wall being beveled and matingly engaging the beveled wall, fasteners extending through the ring and threadingly engaged in threaded apertures of the support plate, the fasteners operable to move the ring toward the seat of the groove from a first position to a second position, a diameter of the ring in the second position being less than that in the first position, the inner peripheral wall of the ring being in a tight engagement with the shaft at least in the second position such that rotation of the support plate relative to the shaft is limited.

3. The adjustable flange assembly of claim 2, wherein the ring has a plurality of circumferentially interspaced indentations defined by the radially inner peripheral wall and by the radially outer peripheral wall.

4. The adjustable flange assembly of claim 1, wherein the adjustment members are fasteners threadingly engaged within threaded apertures extending through the support plate, tips of the fasteners being in abutment against the deformable plate.

5. The adjustable flange assembly of claim 1, wherein the adjustment members includes three adjustment members equally spaced apart from one another.

6. The adjustable flange assembly of claim 1, wherein a thickness of the support plate taken in an axial direction relative to the axis is greater than that of the deformable plate.

7. The adjustment flange assembly of claim 1, wherein the deformable plate is secured to the support plate via fasteners, each of the fasteners circumferentially located between two adjacent ones of the adjustment members.

8. The adjustment flange assembly of claim 7, wherein a radial distance between the adjustment members and the axis is equal to that between the fasteners and the axis.

9. The adjustment flange assembly of claim 1, wherein the first side of the support plate has an elevated section annularly extending around the axis, the reference surface located at the elevated section.

10. An assembly for rotation about a shaft, the shaft having an axis and a shoulder, the assembly comprising:
a cutting tool securable to the shaft and rotatable about the axis, the cutting cool having an axial end annular wall;
an adjustable flange assembly including a support plate and a deformable plate secured to the support plate, the support plate and the deformable plate having registering apertures for slidably receiving the shaft therethrough, the deformable plate abuttable against the shoulder of the shaft and located axially between the axial end annular wall of the cutting tool and the support plate relatively to the axis, a securing mechanism operatively connected to the support plate and operable for releasably securing the support plate to the shaft, adjustment members mounted on one of the support plate and the deformable plate at a plurality of circumferential locations around the axis, the adjustment members being operable to exert a force on the deformable plate to locally deform the deformable plate from an undeformed stated to a deformed state, an axial distance between the support plate and the deformable plate at a corresponding one of the circumferential locations being greater in the deformed state than that in the undeformed state, an axial position of a reference surface defined by the support plate at the corresponding one of the circumferential location varying from the undeformed state to the deformed state.

11. The assembly of claim 10, wherein the securing mechanism includes a ring slidably received within an annular groove located on the first side of the support plate, the annular groove delimited radially by a beveled wall that circumferentially extends around the axis and axially by a seat, the ring having a radially outer peripheral wall and a radially inner peripheral wall, the radially outer peripheral wall being beveled and matingly engaging the beveled wall of the support plate, fasteners extending through the ring and threadingly engaged in threaded apertures of the support plate, the fasteners operable to move the ring toward the seat of the groove from a first position to a second position, a diameter of the ring in the second position being less than that in the first position, the inner peripheral wall of the ring being in a tight engagement with the shaft at least in the second position such that rotation of the support plate relative of the shaft is limited.

12. The adjustable flange assembly of claim 11, wherein the ring has a plurality of circumferentially interspaced indentations defined by the radially inner peripheral wall and by the radially outer peripheral wall.

13. The assembly of claim 10, wherein the adjustment members are fasteners threadingly engaged within threaded apertures extending through the support plate, tips of the fasteners being in abutment against the deformable plate.

14. The assembly of claim 10, wherein the adjustment members includes three adjustment members equally spaced apart from one another.

15. The assembly of claim 10, wherein a thickness of the support plate taken in an axial direction relative to the axis is greater than that of the deformable plate.

16. The assembly of claim 10, wherein the deformable plate is secured to the support plate via fasteners, each of the fasteners circumferentially located between two adjacent ones of the adjustment members.

17. The assembly of claim 16, wherein a radial distance between the adjustment members and the axis is equal to that between the fasteners and the axis.

18. The assembly of claim 10, wherein the first side of the support plate has an elevated section annularly extending around the axis, the reference surface located at the elevated section.

19. A method for securing a cutting tool to a shaft rotatable about an axis, comprising:
abutting a deformable plate of an adjustable flange assembly against a shoulder of the shaft;
securing a support plate of the adjustable flange assembly to the shaft;
abutting the cutting tool against a reference surface defined by a side of the support plate; and
deforming the deformable plate at at least one circumferential location thereby pushing the support plate at the at least one circumferential location in an axial direction relative to the axis away from the shoulder until the reference surface, at the at least one circumferential location, moves to a desired position axially offset from an initial position.

20. The method of claim 19, wherein deforming the deformable plate includes rotating a fastener within a correspondingly threaded aperture of the support plate and pushing the deformable plate, at the at least one circumferential location, away from the support plate with the fastener having a tip in abutment against the deformable plate.
